(19) United States
(12) Patent Application Publication
(10) Pub. No.: US 2009/0069948 A1
(43) Pub. Date: Mar. 12, 2009

(54) SYSTEM AND METHOD FOR CONTROLLING FLUID FLOW

(75) Inventors: Steven G. Nackers, Madison, WI (US); Chad A. Wohlrab, Madison, WI (US)

Correspondence Address: FOLEY & LARDNER LLP, 777 EAST WISCONSIN AVENUE, MILWAUKEE, WI, 53202-5306, US

(73) Assignee: Sub-Zero, Inc.

(21) Appl. No.: 12/191,154

(22) Filed: Aug. 13, 2008

Related U.S. Application Data
(60) Provisional application No. 60/964,798, filed on Aug. 15, 2007.

(51) Int. Cl. G05D 7/00

(52) U.S. Cl. 700/282

(57) ABSTRACT

A method for controlling the flow of fluid in an appliance includes permitting a fluid to flow to an appliance for a first length of time, measuring a volume of the fluid flowing to the appliance during the first length of time, determining a second length of time based on the volume of fluid measured during the first length of time and a final volume of fluid to be provided to the appliance, permitting the fluid to flow to the appliance for the second length of time, and preventing the fluid from flowing to the appliance upon expiration of the second length of time.

### CROSS-REFERENCE TO RELATED PATENT APPLICATIONS

This application claims priority from U.S. Provisional Patent Application No. 60/964,798, filed Aug. 15, 2007, which is hereby incorporated herein by reference in its entirety.

### BACKGROUND

The present application relates generally to the field of monitoring and controlling fluid flow in or to an appliance, and more specifically, to the monitoring and controlling of water flow in a refrigerator and/or freezer, dishwasher, washing machine, or other appliance or device.

Appliances such as refrigerators and freezers are often equipped with devices such as water dispensers, ice makers, or other devices that may utilize a fluid such as water during operation. There are many challenges associated with ensuring that such devices operate optimally. Accordingly, it would be advantageous to provide a system that facilitates the monitoring and controlling of fluids provided to devices and/or appliances such as water dispensers, ice makers, and so on.

### SUMMARY

On embodiment relates to a method for controlling the flow of fluid to an appliance comprising permitting a fluid to flow to an appliance for a first length of time, measuring a volume of the fluid flowing to the appliance during the first length of time, determining a second length of time based on the volume of fluid measured during the first length of time and a final volume of fluid to be provided to the appliance, permitting the fluid to flow to the appliance for the second length of time, and preventing the fluid from flowing to the appliance upon expiration of the second length of time.

Another embodiment relates to a system for controlling the flow of a fluid to an appliance comprising a flow measuring device configured to measure a volume of a fluid provided to the appliance, a flow control device configured to control the flow of the fluid to the appliance, and a computer controller. The computer controller may be configured to direct the flow control device to permit the fluid to flow from the fluid supply to the appliance for a first length of time, receive signals from the flow measuring device during the first length of time indicating a volume of fluid passing the flow measuring device during the first length of time, determine a second length of time based on the volume of the fluid passing the flow measuring device during the first length of time and a final volume of fluid to be provided to the appliance, direct the flow control device to permit the fluid to flow to the appliance for the second length of time, and direct the flow control device to prevent the fluid from flowing to the appliance after expiration of the second length of time.

Yet another embodiment relates to a method of controlling the flow of fluid to an appliance comprising permitting a fluid to flow to an appliance for successive periods of time until a final volume of fluid is provided to the appliance, each successive period of time including an active period of time and a passive period of time; and measuring the volume of fluid provided to the appliance only during the active periods of each successive period of time.

Yet another embodiment relates to a method for controlling the flow of fluid to an appliance comprising permitting a fluid to flow to an appliance for successive periods of time until a calculated total volume of fluid reaches a final volume, each successive period of time comprising (a) permitting the fluid to flow to the appliance for the period of time, (b) determining the calculated total volume of fluid based on the period of time and an assumed flow rate, (c) adjusting the assumed flow rate based on measuring an actual flow rate of the fluid during the period of time, and (d) determining whether the calculated total volume of fluid has reached the final volume.

### BRIEF DESCRIPTION OF THE DRAWINGS

FIG. 1 is a perspective view of an appliance according to an exemplary embodiment.

FIG. 2 is a block diagram of a fluid flow control system for the appliance of FIG. 1 according to an exemplary embodiment.

FIG. 3 is a flow diagram of a first fluid flow control process executed by the fluid flow control system of FIG. 2 according to an exemplary embodiment.

FIG. 4 is a flow diagram of a second fluid flow control process executed by the fluid flow control system of FIG. 2 according to an exemplary embodiment.

FIG. 5 is a flow diagram of a third fluid flow control process executed by the fluid flow control system of FIG. 2 according to an exemplary embodiment.

FIG. 6 is a flow diagram of a fourth fluid flow control process executed by the fluid flow control system of FIG. 2 according to an exemplary embodiment.

FIG. 7 is a flow diagram of a fifth fluid flow control process executed by the fluid flow control system of FIG. 2 according to an exemplary embodiment.

FIG. 8 is a flow diagram of a sixth fluid flow control process executed by the fluid flow control system of FIG. 2 according to an exemplary embodiment.

FIG. 9 is a flow diagram of a seventh fluid flow control process executed by the fluid flow control system of FIG. 2 according to an exemplary embodiment.

FIG. 10 is a flow diagram of a eighth fluid flow control process executed by the fluid flow control system of FIG. 2 according to an exemplary embodiment.

FIG. 11 is a flow diagram of a ninth fluid flow control process executed by the fluid flow control system of FIG. 2 according to an exemplary embodiment.

FIG. 12 is a flow diagram of a tenth fluid flow control process executed by the fluid flow control system of FIG. 2 according to an exemplary embodiment.

FIG. 13 is a flow diagram of a filter monitoring process executed by the fluid flow control system of FIG. 2 according to an exemplary embodiment.

FIG. 14 is a block diagram of a fluid flow control system for the appliance of FIG. 1 according to another exemplary embodiment.

### DETAILED DESCRIPTION

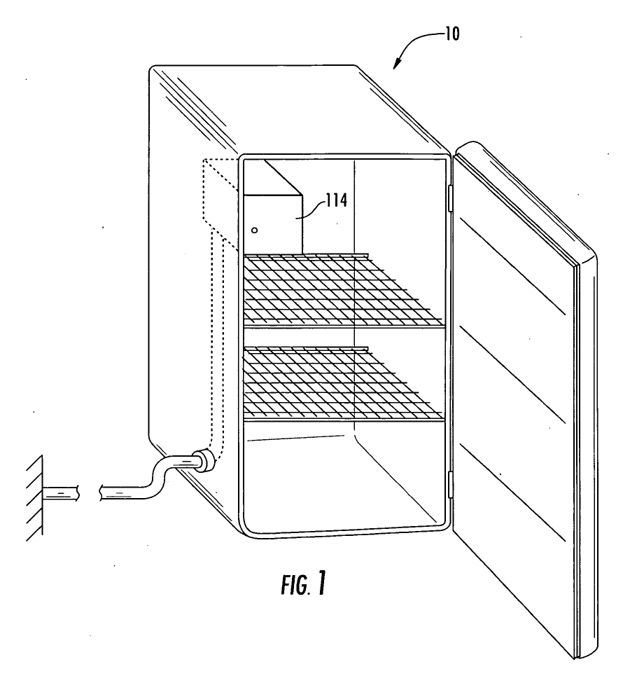

Referring to FIG. 1, an appliance 10 is shown according to an exemplary embodiment. While appliance 10 is generally shown as a refrigerator and freezer combination appliance, according to various other exemplary embodiments, appliance 10 may be a refrigerator only, a freezer only, or any of a variety of different types of appliances and/or other devices. All such appliances and devices are deemed to be within the scope of the present disclosure. According to an exemplary embodiment, appliance 10 includes a fluid-utilizing device 114, such as a water-dispenser, ice-maker, etc. Device 114 may be or include any of a wide variety of devices, structures, appliances, or mechanisms that may utilize fluid as a part of their normal operation.

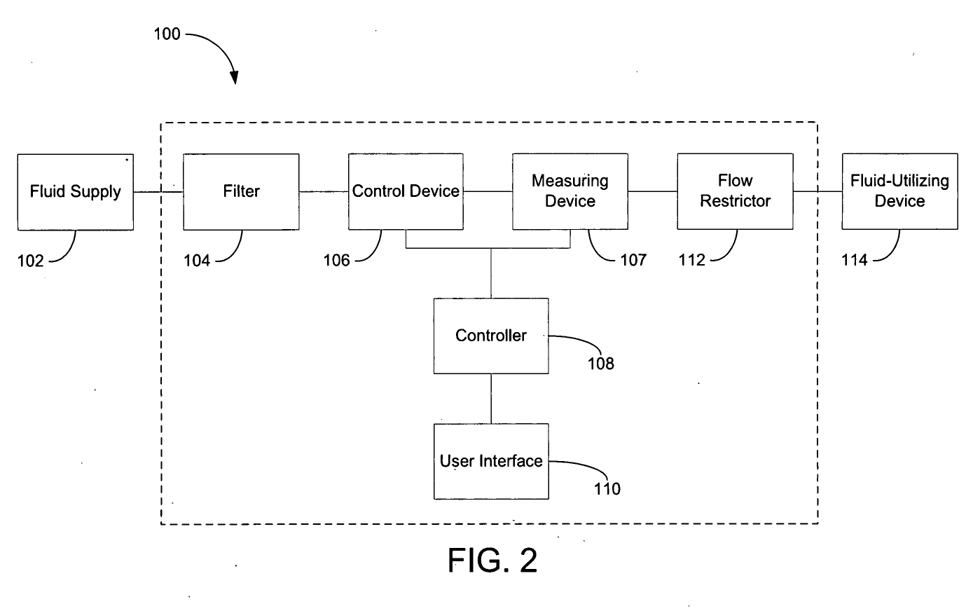

Referring to FIG. 2, device 114 may receive a fluid (e.g., water, etc.) from a fluid supply 102 (e.g., a home water supply, etc.). A fluid flow control system 100 may be utilized to control the flow (e.g., timing, amount, etc.) of fluid from supply 102 to device 114. According to various exemplary embodiments, system 100 may be incorporated into appliance 10 and/or device 114, or may be provided as a separate component from appliance 10 and/or device 114. Device 114, if provided for example, as an icemaker, may be generally configured to freeze water into ice in the shape of ice cubes. The filling of the ice maker may be controlled by system 100. According to other exemplary embodiments, device 114 may be replaced or supplemented by any other device in a refrigerator or other appliance that utilizes fluid and requires fluid from a system such as system 100.

Referring further to FIG. 2, fluid is provided by supply 102, passes through system 100, and is provided to device 114. According to an exemplary embodiment, system 100 may be configured to control water flow to an ice maker and/or a water dispenser, for example, within a refrigerator or other appliance. As shown in FIG. 2, fluid flowing through system 100 may pass by or through a water filter or filter 104, a flow control device 106 (e.g., a valve, such as a single solenoid valve, a dual solenoid valve, etc., and so on), a flow measuring device 107 (e.g., a turbine flow meter, etc.), and a flow restrictor 112 (e.g., a device configured to limit the flow of a fluid to a maximum flow rate). The operation of filter 104, flow control device 106, flow measuring device 107, and/or flow restrictor 112 may be controlled by a controller 108 (e.g., a computer, processor, computing electronics, etc.). Furthermore, according to an exemplary embodiment, a user interface 110 (e.g., an input device, such as a key pad, one or more input buttons, a touch screen or other type of display, and so on) may be provided and coupled to or integrated into controller 108 such that a user may input control parameters to be used by controller 108 in the operation of system 100.

It should be understood that more or fewer components than those shown in and discussed with respect to FIG. 2 may be utilized in conjunction with system 100. For example, system 100 may operate without one or more of filter 104, user interface 110, and flow restrictor 112. Furthermore, system 100 may utilize more than one of any specific component, such as multiple flow controllers/measuring devices, filters, flow restrictors, etc. Further yet, according to some embodiments, components shown as separate components in FIG. 2 may be provided as integral components. For example, flow control device 106 and flow measuring device 107 may be incorporated into a single flow metering valve that includes, for example, a turbine flow metering device and a solenoid valve. Further yet, one or more flow restrictors may be incorporated into a flow metering valve or other components of the system such as a water filter (e.g., filter 104) and so on. All such combinations of components are deemed to be within the scope of the present disclosure.

According to an exemplary embodiment, supply 102 provides a fluid such as water to flow control device 106 via filter 104. The fluid then passes by or through flow measuring device 107, which may be configured such that the volume of water passing by or through flow measuring device 107 may be measured, for example, by monitoring turbine pulses generated by the flow of water or another fluid through a valve. Controller 108 is configured to communicate with flow control device 106 and/or flow measuring device 107 and perform calculations based on inputs received from one or both devices. According to various exemplary embodiments, controller 108 may calculate a volume of water that flows through flow measuring device 107 over a period of time, a difference in rates of fluid flow at different time periods, a time for which flow control device 106 should permit a fluid to flow to an ice maker, water dispenser, or other device, a correction factor, a volume of fluid yet required to flow to a device, etc.

According to an exemplary embodiment, user interface 110 may provide a user with visible and/or audible feedback on the processes executed by system 100 and may allow for user inputs to be entered into system 100. For example, a user may be able to provide system 100 with a predetermined time period, an assumed water flow, a desired final volume of fluid, etc. According to other exemplary embodiments, user interface 110 may be omitted with controller 108 operating with predetermined conditions (e.g., pre-set or predetermined parameters for the operation of system 100).

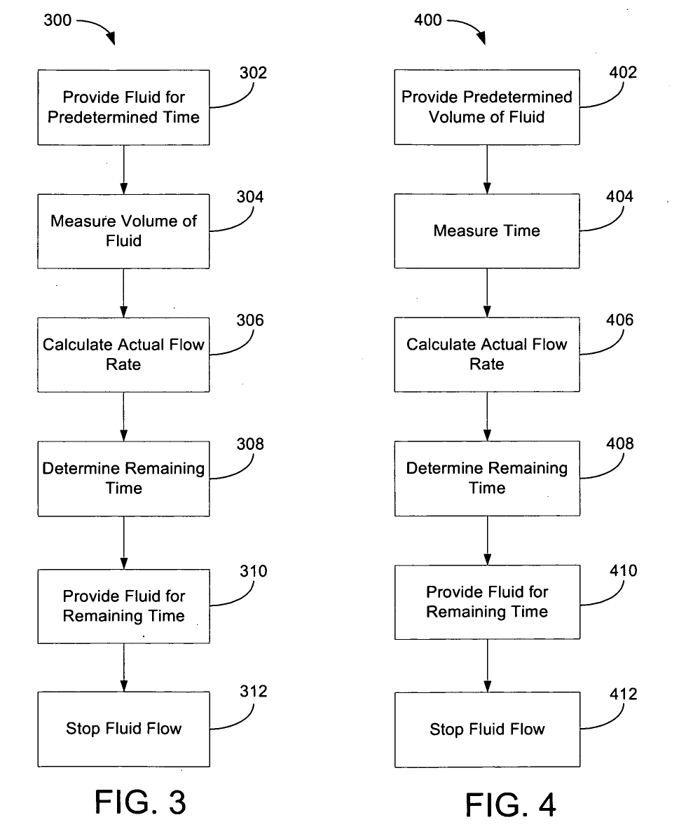

Referring now to FIGS. 3-12, a number of fluid flow control processes (e.g., methods, or algorithms, etc.) are illustrated that may be performed or executed by system 100 according to various exemplary embodiments. The processes may be executed via instructions hardwired onto controller 108, embodied as machine-executable instructions or computer code, or provided in any other suitable fashion so as to be usable by system 100. According to some of the processes herein, system 100 is configured to control the supply of a fluid (e.g., water, etc.) to an appliance and/or a fluid-utilizing device (e.g., a water dispenser, an ice maker, etc.) so as to provide a desired final volume of fluid to the device.

Referring to FIG. 3, a process 300 is shown according to an exemplary embodiment. At step 302, system 100 permits fluid to flow from supply 102 to device 114 for a first length of time (e.g., a predetermined number of seconds, a first length of time or first time period, etc.) by permitting fluid to flow through flow control device 106 (e.g., by maintaining a valve in an open position). According to one exemplary embodiment, the first length of time may be a predetermined length of time and may be less than six seconds. In other embodiments, the predetermined length of time may be a percentage (e.g., 40%, 50%, 60%, etc.) of a total approximate time required to provide a desired final volume of fluid to device 114. According to another exemplary embodiment, the predetermined length of time may be less than ten seconds. At step 304, flow measuring device 107 measures the volume of fluid flowing past device 107 during this initial time period (e.g. by measuring a number of periodic turbine pulses to sense a flow rate of water). At step 306, controller 108 calculates an actual flow rate of the fluid flowing to device 114 based on the volume measured during the first length of time (i.e., actual flow rate=measured volume/length of time). At step 308, controller 108 determines the amount of time (e.g. a second length of time, a second number of seconds, etc., for which fluid will be permitted to flow to device 114) required to provide a desired final volume of fluid to device 114 by determining how long it will take to provide the remaining volume of fluid (e.g., the final volume less the volume of fluid provided during the initial length of time) at the actual flow rate (i.e., the flow rate calculated for the first time period). At step 310, fluid is permitted to flow for the second length of time such that the remaining volume is provided to device 114. At step 312, when the second length of time is expired, flow control device 106 is closed (e.g., by closing a valve, etc.) such that no additional fluid flows to device 114.

Referring to FIG. 4, a process 400 is shown according to an exemplary embodiment. At step 402, controller 108 permits a predetermined volume of fluid to flow from supply 102 to device 114 for a first length of time by permitting fluid to flow through flow control device 106 (e.g., by maintaining a valve in an open position). Step 402 is similar to step 302 discussed with respect to FIG. 3, except that in process 400, the first length of time is not predetermined, but rather is the length of time required to provide a predetermined volume of fluid that is less than a final desired volume. According to another exemplary embodiment, the predetermined volume may be selected such that the first length of time may be less than about six seconds. In some embodiments, the predetermined volume may be selected such that first length of time may be less than about ten seconds. According to one exemplary embodiment, the predetermined volume may be less than, for example, 95% of a final desired volume. According to other embodiments, the predetermined volume may be less than, for example, 50% of the final desired volume. At step 404, controller 108 measures the length of the initial time period (e.g. the time required to provide the predetermined volume of fluid (i.e., the first length of time)). At step 406, controller 108 calculates an actual flow rate of the fluid flowing to device 114 based on the predetermined volume and the first length of time. At step 408, controller 108 determines the amount of time (e.g. a second length of time, a second number of seconds, etc., for which fluid will be permitted to flow to device 114) required to provide the desired final volume of fluid to device 114 by determining how long it will take to provide the remaining volume of fluid (e.g., the total final volume less the volume of fluid provided during the initial length of time) at the actual flow rate (i.e., the flow rate calculated for the first time period). At step 410, fluid is permitted to flow for the second length of time such that the remaining volume is provided to device 114. At step 412, when the second length of time expires, flow control device 106 is closed (e.g., by closing a valve, etc.) such that no additional fluid flows to device 114.

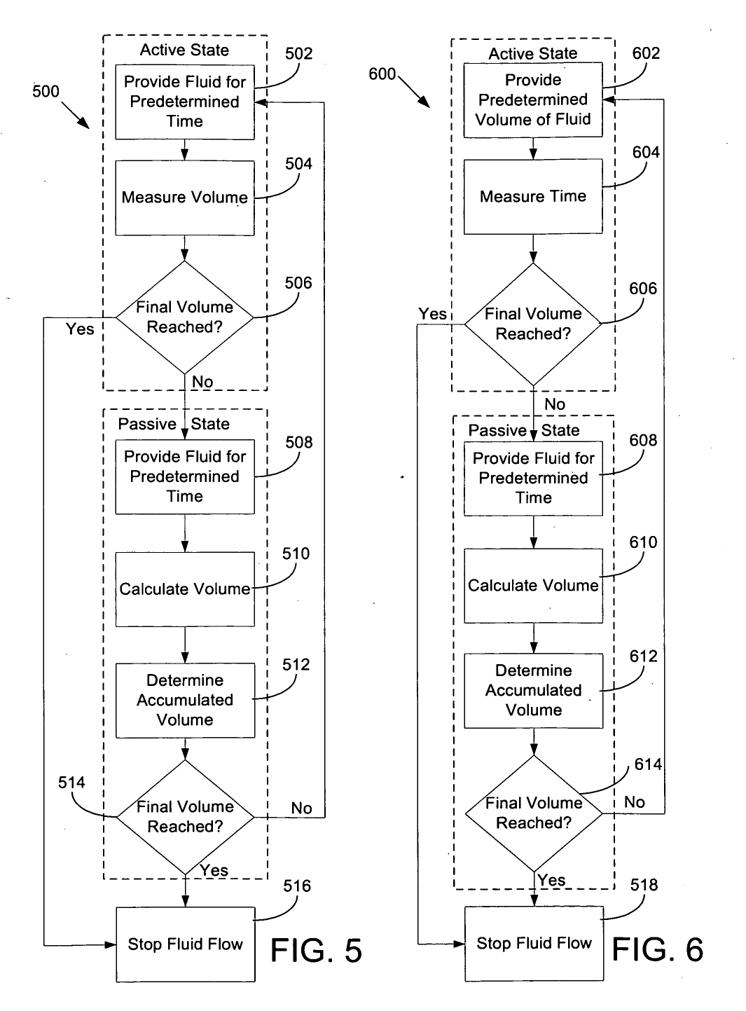

Referring to FIG. 5, a process 500 is shown according to an exemplary embodiment and is configured to provide fluid to device 114 utilizing a series of successive time periods (where each time period includes an active state (e.g., during which controller 108 receives flow measurement data from flow measuring device 107) and a passive state (e.g., during which controller 108 may not utilize flow measurement data from flow measuring device 107)) to provide a desired final volume of fluid to device 114. For example, a total approximated time required to fill, for example, an ice maker, may be ten seconds. Controller 108 may divide this total time into successive one-second time periods. Each one-second period may then be divided into predetermined lengths of time to define an active state and a passive state for each successive period of time. For example a one-second time period may be divided into a 0.7 second active time and a 0.3 second passive time. The successive time periods and active/passive states may be defined in a variety of ways. For example, system 100 may be configured to define the active and passive states as percentages of the successive time periods (e.g., such that the active/passive percentages of each time period may be 25%/75%, 50%/50%, 75%/25%, or any other suitable percentages). According to an exemplary embodiment, the lengths of time for the active and passive states maybe defined so that system 100 operates in an active state for a first total amount of time (e.g., a percentage of a total fill time for an icemaker when all of the distinct active states are added together) and in a passive state for a second total amount of time. According to an exemplary embodiment, during active states, controller 108 is receiving and/or performing calculations based on signals received during the active state. During the passive state, controller 108 may not utilize signals (e.g., from devices 106, 107), but rather may perform calculations based on data received during a previous active state or other data.

At step 502 and in the active state, flow control device 106 permits fluid to flow to device 114 for a predetermined length of time. At step 504, controller 108 measures the volume of fluid that flows to device 114 during the predetermined length of time (i.e., the “active period or state”). Controller 108 may also add this volume to a previously calculated accumulated volume to determine a current accumulated volume of fluid that has been provided to device 114. At step 506, controller 108 determines whether the current accumulated volume has reached a desired final volume, and if so, the process proceeds to step 516. If the final volume has not been reached, at step 508 and in a passive state, flow control device 106 proceeds to permit fluid to flow to device 114 for another predetermined length of time (e.g., the “passive period or state”). Step 508 is considered a part of the passive state because during the passive state, in some embodiments controller 108 is not utilizing flow measurement data (e.g., volume measurements, turbine pulses, etc.) from device 107. Rather, at step 510, controller 108 determines a calculated volume of fluid provided to device 114 during the passive state based upon the length of time of the passive state and the actual flow rate determined during the active state. At step 512, controller 108 determines the current accumulated volume by adding the calculated volume from the passive state to the previous accumulated volume value (from the end of the preceding active state). At step 514, controller 108 determines whether the current accumulated volume has reached the desired final volume, and if so, the process proceeds to step 516. If the desired final volume has not been reached, the process returns to step 502 in an active state, and process 500 continues. At step 516, upon the accumulated volume reaching the desired final volume, controller 108 sends a signal to flow control device 106 to prevent further fluid from flowing to device 114.

According to some embodiments, controller 108 may calculate an average flow rate in an active state to be used in calculating the volume of fluid flowing to device 114 during subsequent passive states. During a first active state, the average flow rate may be equal to the calculated flow rate, but during subsequent active states, controller 108 may average all calculated flow rates to that point in time.

Referring to FIG. 6, a process 600 is shown according to an exemplary embodiment. Similar to process 500, process 600 uses successive time periods having active and passive states. However, rather than defining the active state using predetermined or calculated lengths of time, the active state may be defined by the length of time it takes to provide a first predetermined volume of fluid to device 114. The passive state may then be calculated so that the total estimated amounts of time that system 100 is in either the active and passive states meet predetermined levels (e.g., 25% active and 75% passive, 50% active and 50% passive, and so on).

At step 602 and in an active state, flow control device 106 permits fluid to flow to device 114 so that a predetermined volume of fluid is provided to device 114. At step 604, controller 108 measures the time period of the active state and determines a length of time for the passive state. Controller 108 may also add the predetermined volume to a previously calculated accumulated volume to determine a current accumulated volume of fluid that has been provided to device 114. At step 606, controller 108 determines whether the current accumulated volume has reached the desired final volume, and if so, the process proceeds to step 616. If the desired final volume has not been reached, at step 608 and in a passive state, flow control device 106 proceeds to permit fluid to flow to device 114 for a predetermined length of time (e.g., the “passive state”). Step 608 is considered a part of the passive state because during the passive state, in some embodiments controller 108 may not utilize flow measurement data (e.g., volume measurements) from device 107. Rather, at step 610, controller 108 determines a calculated volume of fluid provided to device 114 during the passive state based upon the length of time of the passive state and the actual flow rate determined during the active state. At step 612, controller 108 determines the current accumulated volume by adding the calculated volume from the passive state to the previous accumulated volume value (from the end of the preceding active state). At step 614, controller 108 determines whether the current accumulated volume has reached the desired final volume, and if so, process 600 proceeds to step 616. If the desired final volume has not been reached, the process returns to step 602 to an active state, and process 600 continues. At step 616, upon the accumulated volume reaching the desired final volume, controller 108 sends a signal to flow control device 106 to prevent further fluid from flowing to device 114.

Similar to process 500, according to an exemplary embodiment, controller 108 may calculate an average flow rate in an active state to be used in calculating the volume of fluid flowing to device 114 during subsequent passive states of process 600. During a first active state, the average flow rate may be equal to the calculated flow rate, but during subsequent active states, controller 108 may average all calculated flow rates to that point in time.

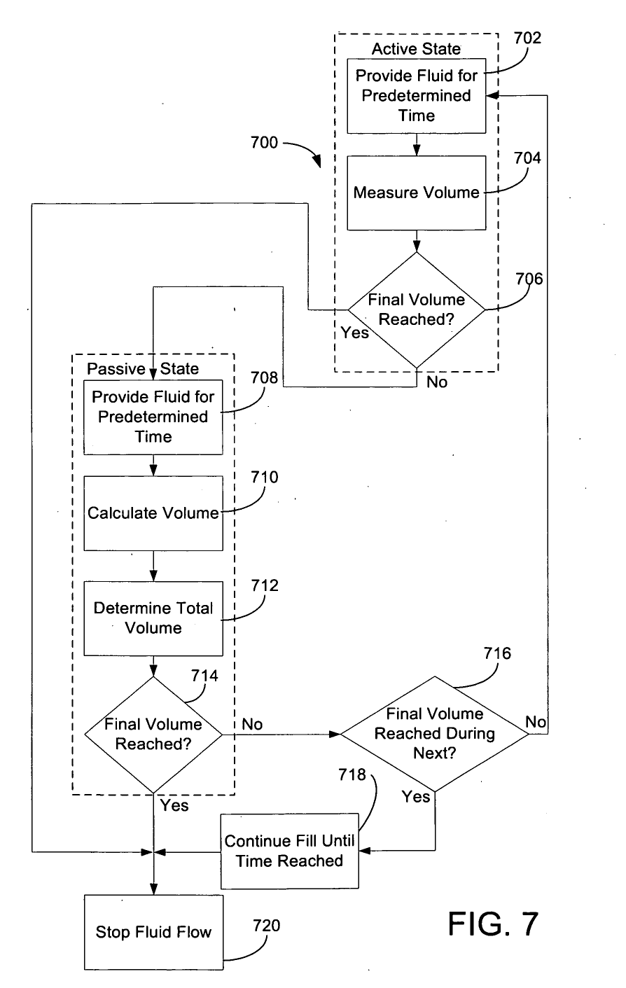

Referring to FIG. 7, a process 700 is shown according to an exemplary embodiment. Process 700 is similar to process 500 shown in and discussed with respect to FIG. 5. For example, process 700 utilizes successive time periods having active and passive states. Similar to process 500, at step 702 and in an active state, flow control device 106 permits fluid to flow to device 114 for a predetermined amount of time. At step 704, controller 108 measures the volume of fluid that flows to device 114 during the active state. Controller 108 may also add this volume to a previously calculated accumulated volume to determine a current accumulated volume of fluid that has been provided to device 114. At step 706, controller 108 determines whether the current accumulated volume has reached the desired final volume, and if so, the process proceeds to step 720. If the final volume has not been reached, at step 708 and in a passive state, flow control device 106 proceeds to permit fluid to flow to device 114 for another predetermined length of time (e.g., the “passive period”). Step 708 is considered a part of the passive state because during the passive state, in some embodiments controller 108 may not utilize flow measurement data (e.g., volume measurements) from device 107 Rather, at step 710, controller 108 determines a calculated volume of fluid provided to device 114 during the passive state based upon the length of time of the passive state and the actual flow rate determined during the active state. At step 712, controller 108 determines the current accumulated volume by adding the calculated volume from the passive state to the previous accumulated volume value (from the end of the preceding active state). At step 714, controller 108 determines whether the current accumulated volume has reached the desired final volume, and if so, process 700 proceeds to step 720. If the desired final volume has not been reached, at step 716 controller 108 predicts whether, at the current average flow rate, the desired final volume will be reached during the next active state. If controller 108 predicts that the desired final volume will be reached during the next active state, rather than system 100 proceeding to an active state, at step 718 controller 108 calculates the required time for the accumulated volume to reach the desired final volume and directs flow control device 106 to permit fluid to flow to device 114 for the appropriate time such that the desired final volume is reached. If, at step 716, controller 108 predicts that the accumulated volume will not reach the desired final volume during the next active state, process 700 returns to step 702 to an active state, and process 700 continues. At step 720, upon the accumulated volume reaching the desired final volume, controller 108 sends a signal to flow control device 106 to prevent further fluid from flowing to device 114.

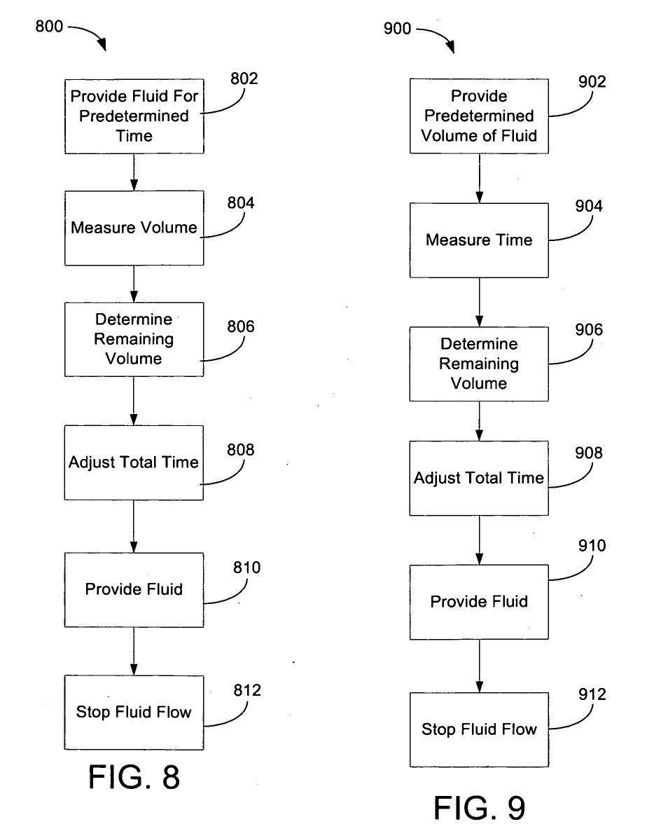

Referring to FIG. 8, a process 800 is shown according to an exemplary embodiment. According to an exemplary embodiment, process 800 may be used to control the flow of fluid to device 114 and adjust a total approximated time for providing fluid to device 114. For example, it may be known that it takes an approximate amount of time to fill an icemaker (assuming certain parameters such as water pressure that may impact the approximate time). However, because the quality of the ice and the efficiency of the icemaker may be sensitive to even small variations in the amount of water provided, it may be advantageous to be able to adjust the approximated amount of time in order to accommodate changes in flow rate (e.g., due to variations in water pressure, clogged or dirty filters, etc.).

At step 802, flow control device 106 permits fluid to flow to device 114 for a predetermined amount of time. According to one exemplary embodiment, the predetermined period of time may be 7 seconds. According to another exemplary embodiment, the predetermined period of time may be between 5 and 10 seconds. According to another exemplary embodiment, the predetermined period of time may be between 0 and 10 seconds. According to still another exemplary embodiment, the predetermined period of time may be user-adjustable. At step 804, controller 108 determines the volume of fluid provided to device 114 based upon signals received from flow measuring device 107. At step 806, controller 108 determines the remaining volume required to provide a desired final volume to device 114. At step 808, controller 108 determines the actual flow rate during the initial time period and, based on the actual flow rate and the remaining volume to be provided, adjusts the total approximated time (e.g., by applying a correction factor to the total approximated time). At step 810, flow control device 106 permits fluid to flow to device 114 until the adjusted total approximate time expires. At step 812, upon the adjusted total approximate time expiring, controller 108 direct flow control device 106 to prevent additional fluid from flowing to device 114.

Referring to FIG. 9, a process 900 is shown according to an exemplary embodiment. Process 900 is similar to process 800 except that process 900 uses an initial predetermined volume, rather than time period, to calculate the actual flow rate. At step 902, flow control device 106 permits fluid to flow to device 114 until a predetermined volume of fluid has been provided to device 114. According to various exemplary embodiments, the predetermined volume may be a predetermined percentage of a desired final volume, or may be a user-configurable value. At step 904, controller 108 measures the length of time required to provide the predetermined volume of fluid to device 114. At step 906, controller 108 determines the remaining volume required to provide a desired final volume to device 114. At step 908, controller 108 determines the actual flow rate during the initial time period and, based on the actual flow rate and the remaining volume to be provided, adjusts a total approximated time (e.g., by applying a correction factor to the total approximated time). At step 910, flow control device 106 permits fluid to flow to device 114 until the adjusted total approximate time expires. At step 912, upon the adjusted total approximate time expiring, controller 108 directs flow control device 106 to close such that no additional fluid is provided to device 114.

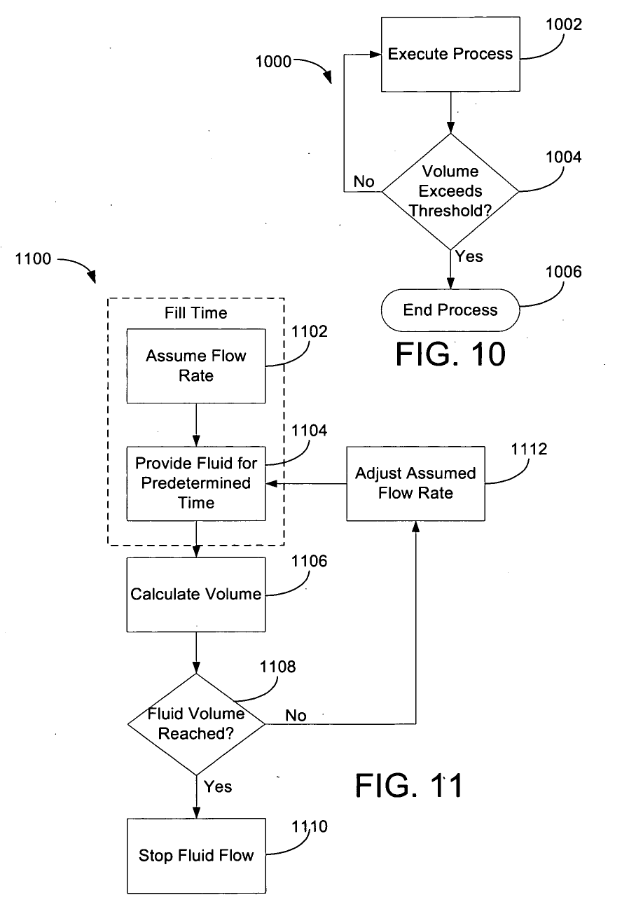

Referring to FIG. 10, a process 1000 is shown according to an exemplary embodiment. Process 1000 may be used alone or in combination with any of the processes shown and described herein. At step 1002, a process (e.g., one of the exemplary processes discussed herein or some other process, etc.) for providing fluid to a device such as device 114 is executed. At step 1004, controller 108 determines whether the volume of fluid provided to device 114 (e.g., during a fill operation for an icemaker) exceeds a predetermined or threshold level (e.g., a target volume that exceeds a desired final volume by a certain amount). If the volume of fluid provided to device 114 exceeds the threshold level, at step 1006 the process providing fluid to device 114 is terminated such that no additional fluid is provided to device 114. According to various exemplary embodiments, process 1000 may be utilized at any time within another process used to control the flow of fluid to device 114. Process 1000 may be used as an “emergency shut-off” feature in addition to another flow control process.

Referring to FIG. 11, a process 1100 is shown according to an exemplary embodiment. At step 1102, controller 108 assumes a flow rate for providing fluid to device 114 (e.g., based on historical, user-provided, or default data, etc.). At step 1104, flow control device 106 permits fluid to flow to device 114 for a predetermined amount of time. At step 1106, controller 108 determines a calculated volume based on the predetermined length of time and the assumed flow rate. Controller 108 may also determine a total accumulated volume of fluid provided to device 114 by adding the current calculated volume to a previously calculated accumulated volume. At step 1108, controller 108 determines whether a final desired volume has been reached, and if so, process 1100 proceeds to step 1110, where flow control device 106 is closed and no additional fluid is provided to device 114. If at step 1108 controller 108 determines that the final desired volume has not been reached, process 1100 proceeds to step 1112, where the assumed flow rate is adjusted based on an actual flow rate calculated for the predetermined period of time. After step 1112, process 1100 returns to step 1104.

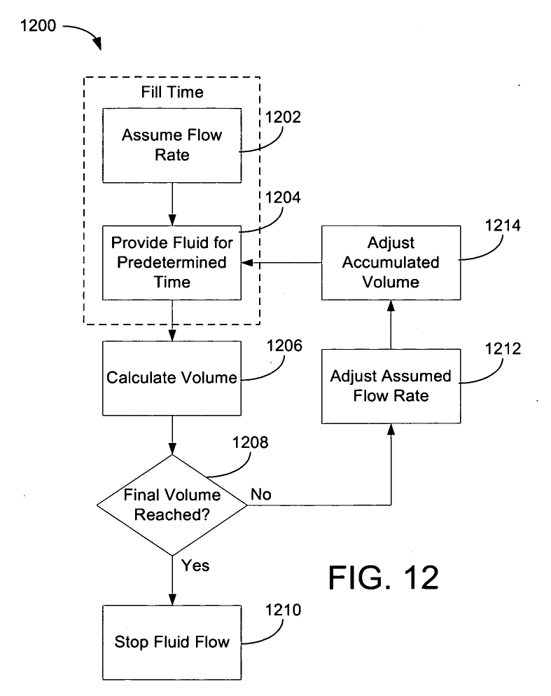

Referring to FIG. 12, a process 1200 is shown according to an exemplary embodiment. Process 1200 is similar to process 1100, except that both the assumed flow rate and the calculated volume may be adjusted based on the actual flow rate. At step 1202, controller 108 assumes a flow rate for providing fluid to device 114 (e.g., based on historical, user-provided, or default data). At step 1204, flow control device 106 permits fluid to flow to device 114 for a predetermined amount of time. At step 1206, controller 108 determines a calculated volume based on the predetermined length of time and the assumed flow rate. Controller 108 may also determine the total accumulated volume of fluid provided to device 114 by adding the current calculated volume to a previously calculated accumulated volume. At step 1208, controller 108 determines whether a desired final volume has been reached, and if so, process 1200 proceeds to step 1210, where flow control device 106 is closed and no additional fluid is provided to device 114. If at step 1208 controller 108 determines that the desired final volume has not been reached, process 1200 proceeds to step 1212, where the assumed flow rate is adjusted based on an actual flow rate calculated during the predetermined period of time. At step 1214, the calculated volume may also be adjusted to reflect an actual volume provided to device 114. After step 1214, process 1200 returns to step 1204.

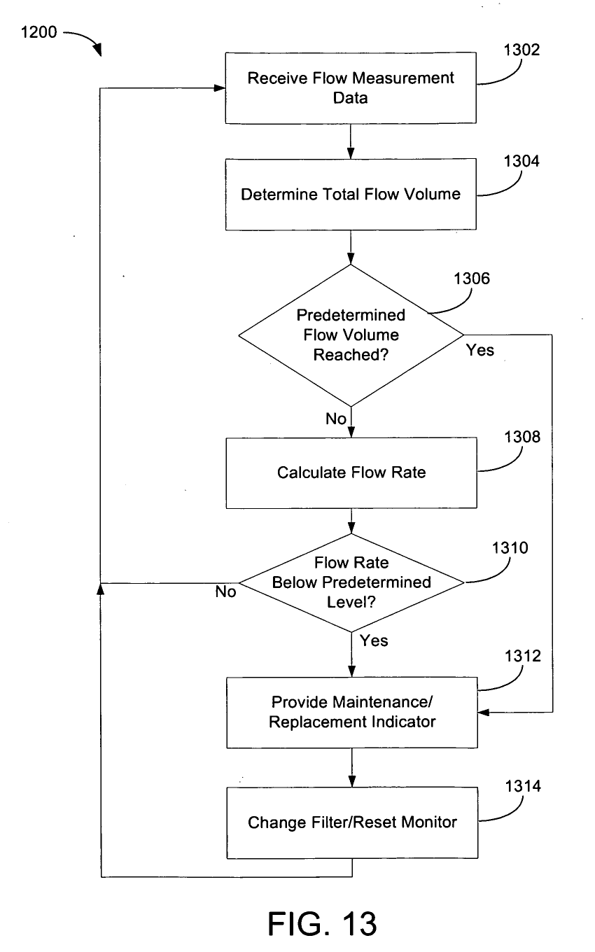

Referring to FIG. 13, a process for monitoring filter use is shown according to an exemplary embodiment. At step 1302, controller 108 receives flow measurement data from flow measurement device 107. At step 1304, controller 108 determines a total volume of fluid that has passed through filter 104 (e.g., during the life of filter 104). At step 1306, the total volume is compared to a predetermined volume level. If the predetermined volume level is reached, process 1300 proceeds to step 1312 where an indication is provided that filter 104 may require replacement and/or maintenance, etc. If the predetermined volume level is not reached, at step 1308 controller 108 calculates the actual flow rate of fluid past filter 104. At step 1310, the actual flow rate is compared to a threshold flow rate. If the actual flow rate is below the threshold flow rate, process 1300 proceeds to step 1312, where an indication is provided that filter 104 may require replacement or maintenance. At step 1314, after replacing filter 104, the volume and/or flow rate measurements are reset such that a new filter may be monitored, and process 1300 returns to step 1302.

According to an exemplary embodiment, filter 104 may comprise a replaceable cartridge with a filter element. Water being delivered to an ice-maker, water dispenser, etc. may pass through the cartridge and be filtered by the filter element. According to an exemplary embodiment, the cartridge may be replaced after a predetermined amount of water has passed through.

In some embodiments, flow control device 106 may include flow measuring device 107, which measures the volume of water that passes through system 100, which in turn is representative of the flow through filter 104. As fluid flows, a signal is sent to controller 108 where a software algorithm tracks the total accumulated fluid flow since the filter cartridge was last replaced and/or a filter life monitor function has been last reset. Once the accumulated flow has reached a predetermined or preset level (“X”), an indication (e.g., “change filter”) on a display panel (e.g., user interface 110, etc.) may be activated. In addition, an intermediate preset level (“Y”) may be utilized to trigger a status indication (e.g., “order filter”) prior to the accumulated flow of fluid reaching level “X.”

In addition to monitoring the life of filter 104 by means of accumulated fluid flow through the cartridge, system 100 may also monitor if a significant drop in average flow rate has occurred prior to reaching preset level “X.” This condition may occur under conditions of high supply water sediment (or other contaminants), thus causing filter 104 to clog prematurely. Under such conditions, system 100 may activate the “change filter” indicator to alert the consumer.

Monitoring the accumulated fluid flow is intended to provide a more accurate means of determining the actual life of a filter cartridge as compared to conventional methods. Conventional methods typically use approximations based on the power-on time of a solenoid water valve and average flow rates through the water valve. These methods may be inaccurate due to the range of actual flow rates that can be caused by variations in water supply pressure. Also, monitoring the accumulated fluid flow is intended to provide a means of determining if a filter is prematurely clogged (e.g., expired) due to worse than normal/expected fluid or water conditions. This may alert the user to the source of a filter or other problem prior to a low flow rate causing other related problems (such as hollow ice cubes or long glass fill times).

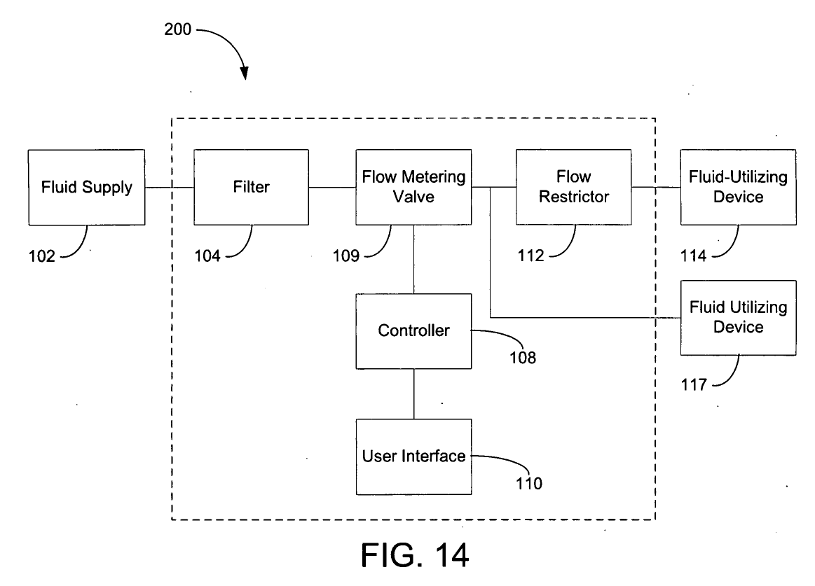

Referring to FIG. 14, a system 200 is shown according to an exemplary embodiment. System 200 is similar to system 100 described with respect to the various exemplary embodiments shown herein, except that as shown in FIG. 14, a flow metering valve 109 may be used in place of flow control device 106 and flow measuring device 107 (shown in, e.g., FIG. 2). The flow metering valve may include a single and/or dual solenoid valve (e.g., to accommodate one or more fluid devices such as fluid devices 114 and 117 shown in FIG. 14). In some embodiments, device 114 may include a water dispenser, and may receive fluid via flow restrictor 112. Device 117 may in some embodiments include an icemaker, and may receive fluid from flow metering valve 109. According to various other embodiments, device 114 and 117 may include or be integrated into a variety of other device and/or appliances, including any of those discussed herein

It should be noted that although some of the exemplary embodiments describe the receipt of turbine pulses (e.g., pulsed from a turbine flow rate meter), any of a variety of flow rate meters may be used to produce one or more signals representative of the flow rate or flow characteristics from which a flow rate or other flow value (e.g., volume, etc.) may be calculated therefrom. Also, although described in the context of a single flow control device and a single flow measurement device for both ice maker fill operations and water dispensing operations, other exemplary embodiments may employ separate devices for each operation.

It should also be noted that although several embodiments are described herein in the context of a single controller, any of a variety of controllers or control systems may be used (e.g., integrated circuits, computers, processors, microcontrollers, microcomputers, programmable logic controllers, application specific integrated circuits, and other programmable circuits, field programmable gate arrays and so on). Controller 108 may be an electronic control, a single controller, or a plurality of separate controllers operating together. The present application contemplates methods, systems, and program products on any machine-readable media for accomplishing its operations. The embodiments of the present application may be implemented using an existing computer processor, or by a special purpose computer processor for an appropriate system, incorporated for this or another purpose or by a hardwired system.

Embodiments within the scope of the present application may include program products comprising machine-readable media for carrying or having machine-executable instructions or data structures stored thereon. Such machine-readable media can be any available media which can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store a desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions comprise, for example, instructions and data which cause a general purpose computer, special purpose computer, or special purpose processing machines to perform a certain function or group of functions.

It should be noted that although the diagrams herein may show a specific order of method steps, it is understood that the order of these steps may differ from what is depicted. Also two or more steps may be performed concurrently or with partial concurrence. Such variation will depend on the software and hardware systems chosen. It is understood that all such variations are within the scope of the present disclosure. Likewise, software implementations of the present application may be accomplished with standard programming techniques with rule-based logic and other logic to accomplish the various connection steps, processing steps, comparison steps, and/or decision steps.

It is important to note that the construction and arrangement of the systems and methods as shown in the various exemplary embodiments is illustrative only. Although only a few embodiments of the present application have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors and orientations) without materially departing from the novel teachings and advantages of the subject matter recited in the claims. For example, elements shown as integrally formed may be constructed of multiple parts or elements, the position of elements may be reversed or otherwise varied, and the nature or number of discrete elements or positions may be altered or varied. Accordingly, all such modifications are intended to be included within the scope of the present application as defined in the appended claims. The order or sequence of any process or method steps may be varied or re-sequenced according to alternative embodiments. Any function clause is intended to cover the structures described herein as performing the recited function and, not only structural equivalents, but also equivalent structures. Other substitutions, modifications, changes, and omissions may be made in the design, operating conditions, and arrangement of the exemplary embodiments without departing from the scope of the present application as expressed in the claims.

What is claimed is:

1. A method for controlling the flow of fluid to an appliance comprising:
permitting a fluid to flow to an appliance for a first length of time;
measuring a volume of the fluid flowing to the appliance during the first length of time;
determining a second length of time based on the volume of fluid measured during the first length of time and a final volume of fluid to be provided to the appliance;
permitting the fluid to flow to the appliance for the second length of time; and
preventing the fluid from flowing to the appliance upon expiration of the second length of time.

2. The method of claim 1 wherein
permitting the fluid to flow to the appliance comprises maintaining at least one valve in an open position; and
preventing the fluid from flowing to the appliance comprises maintaining the at least one valve in a closed position.

3. The method of claim 1 wherein the first length of time is a predetermined length of time.

4. The method of claim 3 wherein the first length of time is between about 50% and about 75% of an approximated total length of time required to provide the final volume of fluid to the appliance.

5. The method of claim 3 wherein a predetermined total time includes the first length of time, and wherein determining the second length of time comprises adjusting the predetermined total time.

6. The method of claim 1 wherein the first length of time is a length of time required to provide a first volume of fluid to the appliance that is less than the final volume.

7. The method of claim 6 wherein the first volume is between about 50% and about 75% of the final volume.

8. The method of claim 6 wherein a predetermined total time includes the first length of time, and determining the second length of time comprises adjusting the predetermined total time.

9. The method of claim 1 further comprising:
receiving an input via a controller coupled to a measuring device configured to measure the volume of fluid flow to the appliance.

10. The method of claim 9 further comprising:
determining the final volume based upon the input.

11. The method of claim 9 further comprising:
determining the first length of time based upon the input.

12. The method of claim 1 further comprising
comparing a total amount of fluid flowing to the appliance during the first and second lengths of time to a threshold volume that is greater than the desired final volume; and
preventing fluid from flowing to the appliance if the total amount of fluid flowing to the appliance reaches the threshold volume.

13. The method of claim 1 further comprising:
directing the fluid to flow to the appliance through a filter; and
providing an indication after at least one of the following occurs:
(a) a predetermined volume of fluid flows through the filter; and
(b) a flow rate of fluid through the filter is measured as being below a predetermined flow rate.

14. The method of claim 13 wherein the indication indicates that the filter may require replacement and/or maintenance.

15. The method of claim 1 wherein the appliance comprises an icemaker.

16. The method of claim 1 wherein the appliance comprises a water dispenser.

17. The method of claim 1, wherein the volume of fluid flowing to the appliance is measured using a turbine flow meter.

18. A system for controlling the flow of a fluid to an appliance comprising:
a flow measuring device configured to measure a volume of a fluid provided to the appliance;
a flow control device configured to control the flow of the fluid to the appliance; and
a computer controller configured to:
direct the flow control device to permit the fluid to flow from the fluid supply to the appliance for a first length of time;
receive signals from the flow measuring device during the first length of time indicating a volume of fluid passing the flow measuring device during the first length of time;
determine a second length of time based on the volume of the fluid passing the flow measuring device during the first length of time and a final volume of fluid to be provided to the appliance;
direct the flow control device to permit the fluid to flow to the appliance for the second length of time; and
direct the flow control device to prevent the fluid from flowing to the appliance after expiration of the second length of time.

19. The system of claim 18 wherein the flow measuring device comprises at least one turbine flow meter.

20. The system of claim 18 wherein the first length of time is a predetermined length of time.

21. The system of claim 18 wherein the first length of time is a length of time required to provide a first volume of fluid to the appliance, the first volume being less than the final volume.

22. The system of claim 18 further comprising a user interface configured to receive an input upon which the final volume is based.

23. A method of controlling the flow of fluid to an appliance comprising:
permitting a fluid to flow to an appliance for successive periods of time until a final volume of fluid is provided to the appliance, each successive period of time including an active period of time and a passive period of time; and
measuring the volume of fluid provided to the appliance only during the active periods of each successive period of time.

24. The method of claim 23 wherein each active period is a predetermined length of time.

25. The method of claim 23 wherein each active period is a length of time required to provide an approximate volume of fluid to the appliance.

26. The method of claim 23 further comprising:
determining whether the final volume of fluid has been reached at the end of each active period.

27. The method of claim 25 further comprising:
determining whether the final volume has been reached at the end of each passive period.

28. The method of claim 23 further comprising:
predicting, at the end of the passive period, a remaining amount of time required to provide a total volume of fluid to the appliance; and
if the remaining amount of time is less than the active period, permitting the fluid t flow to the appliance for the remaining amount of time and then preventing the fluid from flowing to the appliance.

29. The method of claim 23 wherein the volume of fluid provided to the appliance is measured with a turbine flow meter.

30. A method for controlling the flow of fluid to an appliance comprising:
permitting a fluid to flow to an appliance for successive periods of time until a calculated total volume of fluid reaches a final volume, each successive period of time comprising:
(a) permitting the fluid to flow to the appliance for the period of time;
(b) determining the calculated total volume of fluid based on the period of time and an assumed flow rate;
(c) adjusting the assumed flow rate based on measuring an actual flow rate of the fluid during the period of time; and
(d) determining whether the calculated total volume of fluid has reached the final volume.

31. The method of claim 30 further comprising adjusting the calculated total volume of fluid based on a comparison of the assumed flow rate and the actual flow rate.

32. The method of claim 30 wherein adjusting the assumed flow rate includes adjusting the assumed flow rate to the actual flow rate of the fluid during the period of time.

33. The method of claim 30 wherein the actual flow rate is measured using a turbine flow meter.
